(19) United States
(12) Patent Application Publication
(10) Pub. No.: US 2026/0038940 A1
(43) Pub. Date: Feb. 5, 2026

(54) BATTERY PACK

(71) Applicants: Hyundai Motor Company, Seoul (KR); Kia Corporation, Seoul (KR)

(72) Inventors: Myung Sic Choi, Hwaseong-Si (KR); Min Seok Seo, Hwaseong-Si (KR); Chang Mo Sung, Hwaseong-Si (KR)

(73) Assignees: Hyundai Motor Company, Seoul (KR); Kia Corporation, Seoul (KR)

(21) Appl. No.: 19/071,448

(22) Filed: Mar. 5, 2025

(30) Foreign Application Priority Data
Aug. 1, 2024 (KR) 10-2024-0102506

(51) Int. Cl. H01M 50/256; H01M 50/209; H01M 50/264

(52) U.S. Cl. CPC H01M 50/256; H01M 50/209; H01M 50/264

(57) ABSTRACT

A battery pack may exhibit an effect of reducing costs through reduction in number of coupling members including bolts and reducing production costs through a simplified module fastening process by simply integrating a battery module and a surface pressure bracket using a timing belt and fastening a surface pressure bracket to a case to remove bolt holes.

### CROSS-REFERENCE TO RELATED APPLICATIONS

The present application claims priority to Korean Patent Application No. 10-2024-0102506, filed on Aug. 1, 2024, the entire contents of which is incorporated herein for all purposes by this reference.

### BACKGROUND OF THE PRESENT DISCLOSURE

### Field of the Present Disclosure

The present disclosure relates to a battery pack.

### DESCRIPTION OF RELATED ART

A secondary battery that has a high applicability to product groups and electrical characteristics such as a high energy density is generally used for electric vehicles (EV) or hybrid electric vehicles (HEV) driven by an electrical driving source as well as portable appliances. The above-described secondary battery has a primary advantage of being able to significantly reduce use of fossil fuels and gains attention as a new energy source for improving eco-friendliness and energy efficiency in that the secondary battery does not produce byproducts while using energy.

In a typical battery pack manufactured by use of the secondary battery, each of a battery module and a busbar is fixed to a transverse member of a battery case through a bolt to fix the battery module and the busbar to the battery case.

Also, a method of bonding a bracket attachment portion to the case through welding for separately providing is used to fix the surface pressure bracket.

This fixing method causes a limitation in which conductive foreign substances and flammable gases are spread between battery modules in case of thermal runaway of the battery as a gap occurs between the battery modules or between the battery module and the bracket.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery pack having a new structure of coupling a battery module and a surface pressure bracket by use of a belt and fixing the surface pressure bracket to a battery case to remove a gap between battery modules and prevent flammable gases and conductive foreign substances that cause thermal runaway from being accumulated.

An exemplary embodiment of the present disclosure provides a battery pack including: a plurality of battery module assemblies each including a plurality of battery modules disposed in a first direction, each of the battery modules including electrodes and a first belt groove on both sides, a pair of brackets each disposed at either side of the plurality of battery modules and including fastening holes and a second belt groove, and a belt disposed in the first belt grooves and the second belt grooves to surround and fix the plurality of battery modules and the brackets; and a battery case including a base plate, a plurality of bracket attachment portions mounted on the base plate, each of the bracket attachment portions including bracket fixing holes, and a plurality of transverse members disposed perpendicular to the plurality of bracket attachment portions, wherein the plurality of battery module assemblies are fixed to the battery case by the plurality of fastening holes of the brackets being connected to the bracket fixing holes of the plurality of bracket attachment portions by bolt.

In an exemplary embodiment of the present disclosure, the electrodes are disposed below the first belt groove.

In an exemplary embodiment of the present disclosure, each of the pair of brackets includes a height less than a height of each of the battery modules which are surrounded and fixed by the belt e.

In an exemplary embodiment of the present disclosure, the first belt groove may be formed horizontally in first and second side surfaces of each battery module in the first direction.

In an exemplary embodiment of the present disclosure, the second belt groove may be formed horizontally in first and second side surfaces and a front surface of each bracket.

In an exemplary embodiment of the present disclosure, the plurality of fastening holes may vertically pass therethrough.

In an exemplary embodiment of the present disclosure, each of the transverse members is hollow thereinside and further includes a plurality of busbar seat portions each in an opening shape which is cut in a “L”-shape from either side surface to at least a portion of a top surface thereof.

In an exemplary embodiment of the present disclosure, the plurality of busbar seat portions are alternatively formed in first and second side surfaces of the corresponding transverse member in the first direction thereof.

In an exemplary embodiment of the present disclosure, a battery module assembly includes: a plurality of battery modules disposed in a first direction, each of the battery modules including electrodes and a first belt groove on both sides; a pair of brackets each disposed at either side of the plurality of battery modules and including fastening holes and a second belt groove; and a belt disposed in the first belt grooves and the second belt grooves to surround and fix the plurality of battery modules and the pair of brackets.

In an exemplary embodiment of the present disclosure, the electrodes are disposed below the first belt groove.

In an exemplary embodiment of the present disclosure, each of the pair of brackets includes a height less than a height of each of the battery modules which are surrounded and fixed by the belt.

In an exemplary embodiment of the present disclosure, the first belt groove may be formed horizontally in first and second side surfaces of each battery module in the first direction.

In an exemplary embodiment of the present disclosure, the second belt groove may be formed horizontally in first and second side surfaces and a front surface of each bracket.

In an exemplary embodiment of the present disclosure, the plurality of fastening holes may vertically pass therethrough.

In an exemplary embodiment of the present disclosure, the electrode may be formed below each of both the sides at which the first belt groove is formed.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a battery module assembly included in a battery pack according to an exemplary embodiment of the present disclosure.

FIG. 2 is an exploded view exemplarily illustrating a battery module assembly included in the battery pack according to an exemplary embodiment of the present disclosure.

FIG. 3 is a view exemplarily illustrating a top surface of the battery module assembly included in the battery pack according to an exemplary embodiment of the present disclosure.

FIG. 4 is a view exemplarily illustrating a side surface of the battery module assembly included in the battery pack according to an exemplary embodiment of the present disclosure.

FIG. 5 is a view exemplarily illustrating a battery case included in the battery pack according to an exemplary embodiment of the present disclosure.

FIG. 6 is a top view exemplarily illustrating a state in which the battery module assembly is coupled to the battery case included in the battery pack according to an exemplary embodiment of the present disclosure.

FIG. 7 is a view exemplarily illustrating a state in which the battery module assembly is coupled to the battery case included in the battery pack according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Since the present disclosure may have diverse modified embodiments, exemplary embodiments are illustrated in the drawings and are described in the detailed description of the present disclosure. However, this does not limit the present disclosure within the specific embodiments and it should be understood that the present disclosure covers all the modifications, equivalents, and replacements within the idea and technical scope of the present disclosure.

It will be understood that although the terms of “first” and “second” are used herein to describe various elements, these elements should not be limited by these terms. Terms are only used to distinguish one component from other components.

The term “and/or” is used to include all possible combinations of the listed items. For example, “A and/or B” includes all three cases of “A”, “B”, and “A and B”.

It will also be understood that when an element is referred to as being “connected to” or “engaged with” another element, it may be directly connected to the other element, or intervening elements may also be present. It will also be understood that when an element is referred to as being ‘directly connected to’ another element, there is no intervening elements.

In the description of embodiments, it will be understood that when a layer (or film), region, pattern or structure is referred to as being ‘on’ or ‘under’ another layer (or film), region, pad or pattern, the terminology of ‘on’ and ‘under’ includes both the meanings of ‘directly’ and ‘indirectly’. Although the terms “above/upper” or “below/lower” are used to indicate the relative positional relationship between components based on the appearance shown in the drawings for convenience, the terms do not limit the substantial positions of the components. For example, “B above A” simply indicates that B is illustrated above A in the drawing unless otherwise specified or unless A should be disposed above B due to properties of A and B. However, in a substantially realized product, B may be disposed below A, or B and A may be disposed at left and right sides.

In the drawings, the dimensions and size of each layer (or film), region, pattern or structure may be exaggerated, omitted, or schematically illustrated for convenience in description and clarity.

In the following description, the technical terms are used only for explaining a specific exemplary embodiment while not limiting the present disclosure. The terms of a singular form may include plural forms unless referred to the contrary. The meaning of ‘include’ or ‘comprise’ specifies a property, a region, a fixed number, a step, a process, an element and/or a component but does not exclude other properties, regions, fixed numbers, steps, processes, elements and/or components.

Unless terms used in the present disclosure are defined differently, the terms may be construed as meaning known to those skilled in the art. Terms such as terms that are generally used and have been in dictionaries should be construed as having meanings matched with contextual meanings in the art. In the present description, unless defined clearly, terms are not ideally, excessively construed as formal meanings.

Hereinafter, various exemplary embodiments included in the present specification is described with reference to the accompanying drawings, and the same or corresponding components are provided with the same drawing number regardless of reference number, and their duplicated description will be omitted.

A battery pack according to an exemplary embodiment of the present disclosure includes a battery module assembly 100 and a battery case 191.

The battery module assembly 100 includes a plurality of battery modules 110, a plurality of surface pressure brackets 160, and a fixing belt 190.

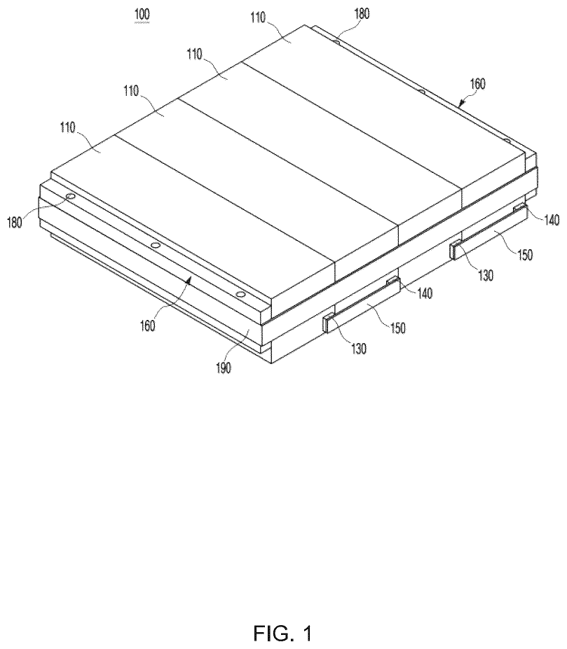

The plurality of battery modules 110 are disposed in a longitudinal direction while a first belt groove 120 is formed in both side surfaces of the battery modules 110. In the exemplary embodiment of the present disclosure, four battery modules 110 may form one set as illustrated in FIG. 1. The number of the plurality of battery modules 110 may be four or more depending on embodiments.

The battery module 110 represents a battery which is packaged by stacking and attaching pouch-type battery cells in layers to be manufactured into one module.

The one battery module 110 has a rectangular shape which is elongated in a longitudinal direction thereof.

The first belt groove 120 is formed in a side surface in a horizontal direction as mentioned above. The first belt groove 120 is formed in a side surface having a small area. The first belt groove 120 may have a depth greater than or equal to that of the fixing belt 190 which will be described later.

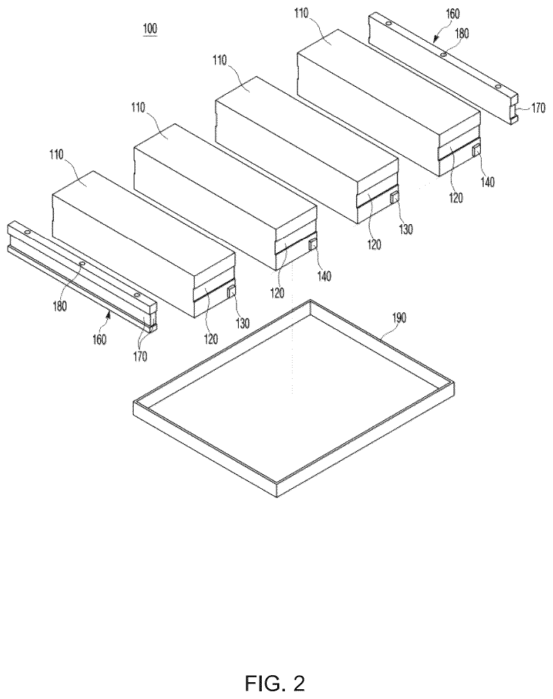

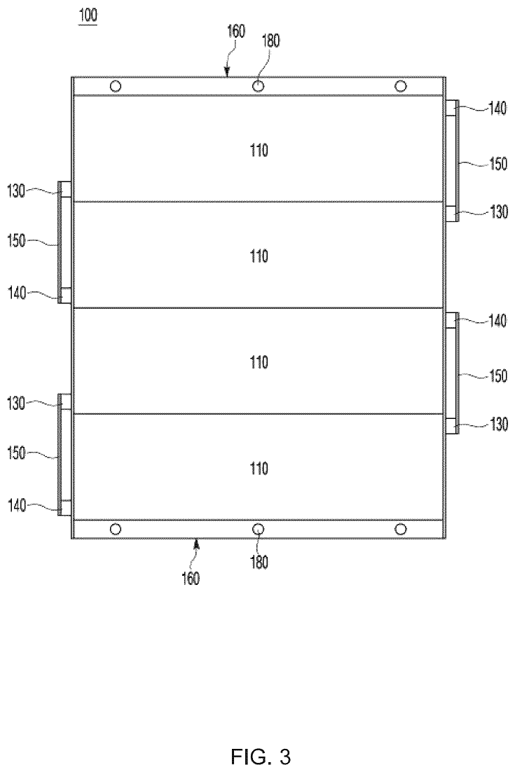

An electrode may be formed on each of both sides of the battery module 110 as illustrated in FIG. 2 and FIG. 3. The electrode may be disposed below the first belt groove 120 formed on the side surface. The electrode may be formed on each of both side surfaces of each of four battery modules 110.

In each of the battery modules 110, a positive (+) electrode 130 is formed on one side surface having a small area, and a negative (−) electrode 140 is formed on the other side surface having a small area.

Among the four battery modules 110, each of two battery modules 110 includes the positive (+) electrode 130 and the negative (−) electrode 140 formed on one side surface and the other side surface thereof, respectively, and each of the rest two battery modules 110 includes the negative (−) electrode 140 and the positive (+) electrode formed on one side surface and the other side surface thereof, respectively.

Referring to FIG. 3, the positive (+) electrode 130 or the negative (−) electrode 140 formed on one side surface and the other side surface, respectively, is formed on a right lower portion. This may bring an effect of preventing busbars 150 of the plurality of battery module assemblies 100 from interfering each other when the battery module assembly 100 is assembled to a battery case 191 that will be described later.

In the four battery modules 110, the battery modules 110 including the positive (+) electrode 130 and the negative (−) electrode 140 at different positions may be alternately disposed.

When the battery modules 110 including the positive (+) electrode 130 and the negative (−) electrode 140 at different positions are alternately disposed as described above, the positive (+) electrode 130 and the negative (−) electrode 140 are alternately formed as illustrated in FIG. 2.

Through this, the four battery modules 110 may be connected in series by connecting the positive (+) electrode 130 and the negative (−) electrode 140 by use of the plate-shaped busbar 150.

Referring to FIG. 2, a plurality of fastening holes 180 pass vertically from top surfaces of the plurality of surface pressure brackets 160.

In the exemplary embodiment of the present disclosure, two surface pressure brackets 160 are provided, and the two surface pressure brackets 160 are disposed on both sides, respectively, of the four battery modules 110 disposed in the longitudinal direction thereof.

As illustrated in FIG. 3, a second belt groove 170 is formed in each of the side surfaces of the surface pressure bracket 160. The second belt groove 170 may have the same depth and vertical width as those of the above-described first belt groove 120.

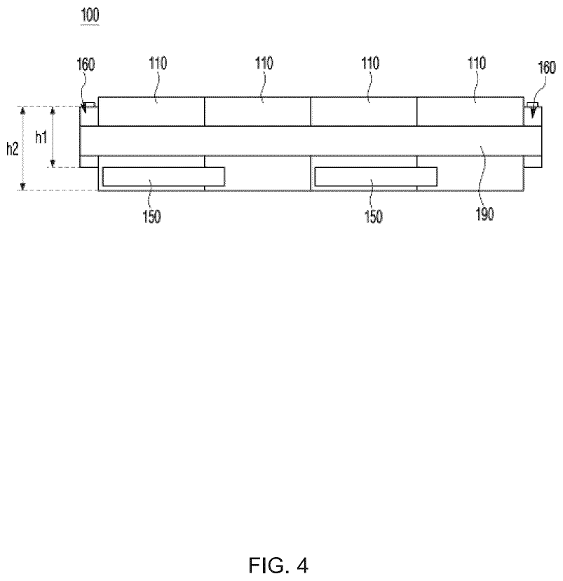

As illustrated in FIG. 4, the surface pressure bracket 160 may have a height h1 less than a height h2 of the battery module 110.

The surface pressure bracket 160 is coupled with the plurality of battery modules 110 through the fixing belt 190 that will be described later.

Here, since a bracket attachment portion 210 is provided below the surface pressure bracket 160, a space for the bracket attachment portion 21 is required.

To the present end, as illustrated in FIG. 4, the surface pressure bracket 160 may be coupled in a state of being spaced upwards from a bottom surface of the battery module 110 while being disposed on the side surface of the battery module 110.

As illustrated in FIG. 1, the fixing belt 190 may be provided in the first belt groove 120 and the second belt groove 170 to surround and fix the plurality of battery modules 110 and the surface pressure brackets 160. The fixing belt 190 may be made of, e.g., a metal material.

In an exemplary embodiment of the present disclosure, the fixing belt 190 may be made of a rubber material. In case of the fixing belt 190 made of a metal material, the fixing belt 190 may surround the plurality of battery modules 110 and the surface pressure brackets 160 and fix end portions thereof through spot welding. In case of the fixing belt 190 made of a rubber material, the fixing belt 190 may fix the plurality of battery modules 110 and the surface pressure brackets 160 through a belt having a closed curve shape.

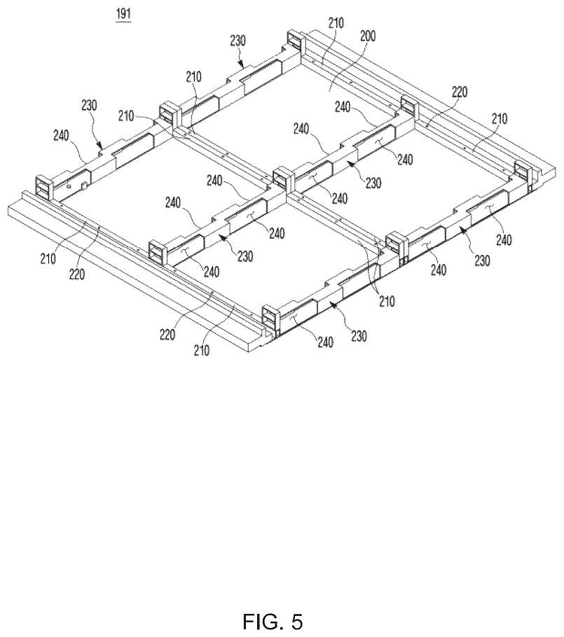

Referring to FIG. 5, the battery case 191 includes a base plate 200 and a plurality of bracket attachment portions 210 provided on a top surface of the base plate 200 through welding.

The bracket attachment portion 210 includes bracket fixing holes 220 that are spaced a preset distance from each other on the base plate 200 and vertically formed in a top surface of the base plate 200.

Transverse members 230 cross the plurality of bracket attachment portions 210 and are provided between the plurality of bracket attachment portions 210. In each of the transverse members 230, a lower portion and both sides in a longitudinal direction thereof may be fixed to the base plate 200 and the bracket attachment portion 210, respectively, through welding.

The transverse member 230 may have a rectangular pipe shape including an internal hollow portion or a “ [symbol] ”-shaped channel including a top surface and both side surfaces. In the transverse member 230, a busbar seat portion 240 communicating with the hollow portion is formed in a side surface of the transverse member 230 so that the busbar 150 is inserted therein.

As the hollow portion is formed in the transverse member 230, an effect of smoothly discharging a conductive foreign substance and a flammable gas through the hollow portion when a thermal runaway occurs may be obtained.

In an exemplary embodiment of the present disclosure, a refractory material may be filled in the hollow portion to prevent heat generated when a thermal runaway occurs from transferring to another battery module assembly 100.

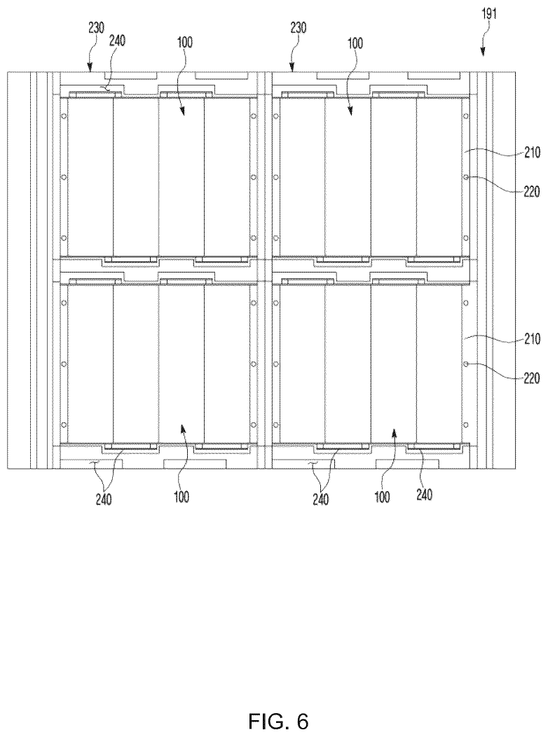

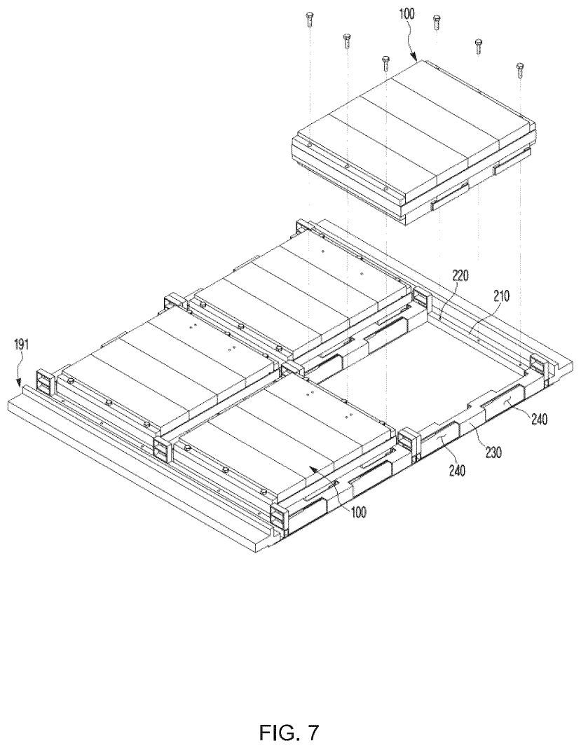

As illustrated in FIG. 5, FIG. 6 and FIG. 7, the busbar seat portion 240 may have an opening shape which is cut in a “L”-shape from both side surfaces to at least a portion of a top surface of the transverse member 230 so that an external portion thereof communicates with the hollow portion, preventing the busbar 150 from being interfered by the transverse member 230 when the battery module assembly 100 is provided in the battery case 191. Through this, an effect of allowing the battery module to be easily seated thereon may be obtained.

As illustrated in FIG. 5 and FIG. 6, the busbar seat portion 240 may be alternately formed at both sides of the transverse member in the longitudinal direction thereof.

That is, when the busbar seat portion 240 is formed at one side surface of the transverse member 230, the busbar seat portion 240 is not symmetrically formed on the opposite side surface.

Through this, an effect of preventing strength from decreasing when the busbar seat portion 240 is formed in the transverse member 230.

Next, a process of providing a battery pack by mounting a battery module assembly 100 in a battery case 191 according to an exemplary embodiment of the present disclosure will be described.

First, as described above, the battery module assembly 100 is obtained by coupling a plurality of battery modules 110 and a plurality of surface pressure brackets 160 through fixing belts 190.

When the plurality of battery modules 110 and the plurality of surface pressure brackets 160 are completely coupled to each other, a positive (+) electrode 130 and a negative (−) electrode 140 formed on each battery module 110 are connected through a busbar 150 by spot welding.

The battery case 191 is obtained by bonding and coupling a bracket attachment portion 210 and a transverse member 230 to a base plate 200 by welding.

When the battery case 191 is provided, the above-described battery module assembly 100 is disposed in a space within two transverse members 230 and two bracket attachment portions 210.

Here, the surface pressure brackets 160 are disposed on the bracket attachment portions 210. When the surface pressure brackets 160 are disposed on the bracket attachment portions 210, the battery module assembly 100 is fixed by aligning fastening holes 180 and bracket fixing holes 220 to each other and coupling the surface pressure brackets 160 and the bracket fixing holes 220 through bolts.

The bolt holes may be removed by simply integrating the battery module and the surface pressure bracket using the timing belt and fastening the surface pressure bracket to the case. Thus, the material costs may be reduced by the reduction in the number of coupling members including bolts, and the production costs may be reduced by the simplification in the module fastening process.

Also, although the module may be detached only when the busbar is removed during the battery pack repair in the typical structure, the present disclosure may easily detach the battery module by loosening only the coupling members including bolts that fix the surface pressure bracket.

Also, since the battery module is fixed by the surface pressure bracket, the present disclosure may allow the better space use because the transverse member does not need a separate fixing structure and the flexible layout configuration because the busbar is accommodated in the transverse member.

Technical objects to be solved as an exemplary embodiment of the present disclosure are not limited to the aforementioned technical objects and unmentioned technical objects will be clearly understood by those skilled in the art to which an exemplary embodiment of the present disclosure belongs.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing predetermined embodiments, and are not intended to limit the embodiments. As used in the description of the exemplary embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery pack comprising:
a plurality of battery module assemblies each including:
a plurality of battery modules disposed in a first direction, each of the battery modules including electrodes and a first belt groove on first and second sides thereof;
a pair of brackets each disposed at either side of the plurality of battery modules and including fastening holes and a second belt groove; and
a belt disposed in the first belt grooves and the second belt grooves to surround and fix the plurality of battery modules and the brackets in the belt; and
a battery case including:
a base plate;
a plurality of bracket attachment portions installed on the base plate in a second direction, each of the bracket attachment portions including bracket fixing holes; and
a plurality of transverse members disposed perpendicular to the plurality of bracket attachment portions,
wherein the plurality of battery module assemblies are fixed to the battery case by the plurality of fastening holes of the brackets being connected to the bracket fixing holes of the plurality of bracket attachment portions by coupling members.

2. The battery pack of claim 1, wherein the electrodes are disposed below the first belt groove.

3. The battery pack of claim 1, wherein each of the pair of brackets has a height less than a height of each of the battery modules which are surrounded and fixed by the belt.

4. The battery pack of claim 1, wherein the first belt groove is formed horizontally in first and second side surfaces of each battery module in the first direction.

5. The battery pack of claim 1, wherein the second belt groove is formed horizontally in first and second side surfaces and a front surface of each bracket.

6. The battery pack of claim 1, wherein the plurality of fastening holes vertically pass therethrough the pair of brackets.

7. The battery pack of claim 1, wherein each of the transverse members is hollow there inside and further includes a plurality of busbar seat portions each in an opening shape which is cut in a “L”-shape from either side surface to at least a portion of a top surface thereof.

8. The battery pack of claim 7, wherein the plurality of busbar seat portions are alternatively formed in first and second side surfaces of the corresponding transverse member in the first direction.

9. The battery pack of claim 7, wherein the transverse members cross the plurality of bracket attachment portions and are provided between the plurality of bracket attachment portions.

10. A battery module assembly comprising:
a plurality of battery modules disposed in a first direction, each of the battery modules including electrodes and a first belt groove on first and second sides of each battery module;
a pair of brackets each disposed at either side of the plurality of battery modules and including fastening holes and a second belt groove; and
a belt disposed in the first belt grooves and the second belt grooves to surround and fix the plurality of battery modules and the pair of brackets in the belt.

11. The battery module assembly of claim 10, wherein the electrodes are disposed below the first belt groove.

12. The battery module assembly of claim 10, wherein each of the pair of brackets has a height less than a height of each of the battery modules which are surrounded and fixed by the belt.

13. The battery module assembly of claim 10, wherein the first belt groove is formed horizontally in first and second side surfaces of each battery module in the first direction.

14. The battery module assembly of claim 10, wherein the second belt groove is formed horizontally in first and second side surfaces and a front surface of each bracket.

15. The battery module assembly of claim 10, wherein the plurality of fastening holes vertically pass therethrough the pair of brackets in a second direction.
